(19) United States
(12) Patent Application Publication
(10) Pub. No.: US 2026/0366488 A1
(43) Pub. Date: Nov. 19, 2026

(54) Method for controlling a wind power Installation in the event of a safety stop

(71) Applicant: Wobben Properties GmbH, Aurich (DE)

(72) Inventors: Henry Mühlenbrock, Hinte (DE); Michael Stämmler, Zwingenberg (DE); Nils-Hendric Schall, Berlin (DE); Christopher Schuirmann, Aurich (DE)

(73) Assignee: Wobben Properties GmbH, Aurich (DE)

(21) Appl. No.: 19/173,050

(22) Filed: Apr. 8, 2025

(30) Foreign Application Priority Data
Apr. 9, 2024 (EP) 24169130.2

(51) Int. Cl. F03D 7/02; H02P 9/08; H02P 101/15

(52) U.S. Cl. CPC F03D 7/0264; F03D 7/0224; H02P 9/08; F05B 2270/326; H02P 2101/15

(57) ABSTRACT

The present disclosure relates to a method for controlling a wind power installation, the wind power installation having an aerodynamic rotor with rotor blades which are able to be adjusted in terms of their blade angle, and the rotor being able to be operated at a variable rotor speed, the rotor blades being moved toward a feathered position in order to stop the rotor, the stopping being triggered by a trigger event and if a safety stop is triggered on the basis of the trigger event, one of a plurality of control strategies for performing the safety stop being additionally selected on the basis of the trigger event.

### CROSS-REFERENCE TO RELATED APPLICATIONS

This application claims the benefit of priority to European application number 24169130.2, filed on Apr. 9, 2024, which is expressly incorporated by reference herein in its entirety.

### TECHNICAL FIELD

The present disclosure relates to a method for controlling a wind power installation and the present disclosure relates to a corresponding wind power installation.

### BACKGROUND

Wind power installations are known; they generate electrical power from wind in order to feed said power into an electrical supply grid. However, while doing so, various events which necessitate the stopping of the wind power installation can occur.

The wind power installation, which can simplistically also be referred to as a wind turbine or turbine, can perform various stopping operations depending on the event which leads to the turbine being stopped. Particularly, a distinction can be made regarding how urgently and quickly the stopping operation has to be performed. To stop the wind power installation, at least the rotor blades are adjusted, this also being referred to as pitching. In particular, the rotor blades are turned into a feathered position in order to stop. Moreover, the generator torque, which is controlled to zero at least at the end of the stopping operation, is adapted.

How exactly the pitching proceeds, in particular whether a profile, that is to say a temporal curve of the blade adjustment, is used for this, and how such a profile is formed, and also how exactly the generator torque is adapted, may depend on the event which triggers the stopping operation. Particularly in the event of a safety stop, the stopping should be performed as quickly as possible, this accordingly also possibly leading to quick adjustment of the rotor blades.

It is also considered here that the stopping operations are distinguished by the hardware unit which controls the respective stopping operation.

It is also considered that a plurality of events initiate a stopping operation at the same time and then prioritization of the available stopping procedures is carried out on the basis of the event, controller and/or the hardware unit which controls the stopping operation. Accordingly, stopping procedures can be predefined and then performed depending on the event.

In this case, a safety stop is assigned the highest priority.

When performing such a stopping operation, it must be ensured that loads are not exceeded. For this purpose, it can be ensured during a rating process that the rated loads are not exceeded by any of the stopping operations, that is to say predetermined stopping procedures. This can be done by limiting a possible pitch rate, that is to say adjustment rate for the blade angles, to a limit value.

A stopping procedure is provided for the safety stop in this case; other stopping procedures are provided for other stops.

Particularly when carrying out a safety stop, there can be high loads on the wind power installation in this case because, in the event of a safety stop, the wind power installation often has to be stopped quickly and often also not all options for the operational control are available for controlling the stopping operation decisively; this is because such a safety stop is frequently performed in connection with an error, which may also relate to an error in the installation controller, such that the installation controller may then no longer be fully available.

### SUMMARY

The present disclosure is therefore based on the object of addressing at least one of the problems mentioned above. In one example, the intention is to provide a solution in which the stopping of the installation is carried out with as low a load as possible, even in the event of safety stops. The intention is at least to propose an alternative solution to previously known solutions.

According to the disclosure, a method as claimed in claim 1 is proposed. The method therefore relates to the control of a wind power installation which has an aerodynamic rotor with rotor blades which are to be adjusted in terms of their blade angle and in which the rotor is able to be operated at a variable rotor speed. Provision is made for the rotor blades to be moved toward a feathered position in order to stop the rotor. A feathered position is, in one example, a position in which the rotor blades have their leading edge moved toward the wind and their trailing edge moved toward the side facing away from the wind, with regard to an orientation of the wind power installation in which the rotor is oriented toward the wind. The rotor is thus oriented with its rotor plane approximately perpendicular to the wind direction. The rotor blades then have an angle of about 90° and—to put it simply—point toward the wind in the same direction as a rotor axis of the wind power installation, namely with their blade leading edge, which may also be referred to as a blade nose.

It is proposed here that the rotor blades are moved toward a feathered position; they therefore do not necessarily have to adopt exactly this feathered position at the end of the safety stop but rather only be turned in this direction and in this respect the rotor blades are turned out of the wind. Preferably, they reach the feathered position at least up to a tolerated or desired deviation which according to absolute value may be in the range of 0° to 10°. Provision may be made for strategies in which the feathered position does not necessarily need to be reached exactly, for example if the rotor blades are not fixed at the end of the safety stop, this being further explained in more detail below. The feathered position can be about 90°; in some wind power installations it can also be about 100°.

Such stopping is triggered by a trigger event, and different stopping operations, which may also be referred to as a stopping type here, can be triggered on the basis of the trigger event. One such stopping type is a safety stop. A safety stop can thus be triggered on the basis of the trigger event.

It is proposed that if a safety stop is triggered on the basis of the trigger event, one of a plurality of control strategies for performing the safety stop is initially selected on the basis of the trigger event. Such control strategies for performing the safety stop may also be synonymously referred to as safety stop strategies. Performing one of a plurality of such safety stop strategies can be realized by selecting one of a plurality of stored safety stop strategies. However, it also comes into consideration that a safety stop strategy is set, especially in its para-metrization. Again, this means that one of a plurality of control strategies for performing the safety stop is selected.

It has been recognized here that not just a single control strategy for performing the safety stop should be provided, that is to say not just a single safety stop strategy, but rather that a plurality of safety stop strategies should be provided because even in the event of a safety stop different conditions can occur. Such different conditions can relate to the trigger event, but also the current situation in which the wind power installation finds itself, that is to say whether it has a high or low speed, for example, and which position the rotor blades are in with respect to their blade angle. The ambient weather conditions can also play a role.

A safety stop can be distinguished by the fact that its trigger events are stored as safety-relevant trigger events in a safety table. A safety stop may additionally or alternatively be distinguished by the fact that its trigger events, insofar as they are quantifiable, relate to the violation of a safety limit value. In this case, exceeding a limit speed, exceeding a limit load and/or exceeding a limit vibration amplitude, to name just a few examples, come into consideration.

According to one aspect, it is proposed that the control strategies are each based on a trajectory. In one example, such a trajectory is followed in whole or in part. The wind power installation is thus stopped along such a trajectory.

The trajectory can be distinguished in each case by a pitch rate curve and assigned blade angle. Optionally, it is additionally distinguished by an assigned curve of a generator power and/or of a generator torque.

Additionally, or alternatively, the trajectory is distinguished by the pitch rate over time.

It thus comes into consideration that the rotor blades are adjusted on the basis of the pitch rate curve, and in one example according to the pitch rate over time. In this case, a blade angle is assigned to the pitch rate curve such that a particular pitch rate is assigned to a particular blade angle.

In this respect, the assigned blade angle is to be understood as the initial or starting state.

The assigned blade angle is in one example, a target blade angle, and so the pitch rate curve is provided such that this target blade angle is reached. An initial blade angle can also be used for this purpose and the pitch rate curve can be calculated accordingly so that a desired target blade angle is obtained. In this case, the target blade angle may be the same for all the rotor blades but it may also be different, this being further explained below. It also comes into consideration that although a target blade angle is specified, the rotor blades do not need to be fixed after the target blade angle has been reached.

It also comes into consideration that the performed safety stop is followed by a down-stream protection controller or regulator which can additionally adjust the rotor blades slightly in terms of their blade angle or allows a certain self-movement of the rotor blades with respect to their blade angle. In this respect, it also comes into consideration that the assigned blade angle, which is thus assigned to the pitch rate curve, allows a certain tolerance, in any case insofar as it forms a target blade angle.

In addition, a curve of a generator power and/or of a generator torque, which curve is assigned to a selected control strategy, may be provided. In one example, the generator torque is specified in this case on the basis of the speed of the rotor or time. A generator power or a generator torque can thus be set at the same time as the pitch rate curve. This can be specified by the selected control strategy. Blade adjustment, owing to which design loads are complied with, can be specified by the pitch rate curve, this possibly being supplemented by the generator torque or the power. Whether a generator torque or a generator power is set depends in one example, on the general control principle of the wind power installation. In terms of effect, it is essentially the same whether the generator power or the generator torque is controlled. Basically, the generator power is in actual fact influenced by the generator torque.

The trajectory can be distinguished by the pitch rate over time and in this respect the pitch rate curve can then be the pitch rate over time. As a result, the pitch rate can thus be clearly specified and the control strategy for stopping the wind power installation is based on this. If necessary, further settings, such as the generator power or the generator torque, can be based on this.

Insofar as pitch rate and generator power or generator torque are specified as trajectory, the relationships are thus fixed in this trajectory.

According to one aspect, it is proposed that in the event of a safety stop the wind power installation is controlled to a standstill during which the rotor no longer rotates and is in a safe position. A safe position can be a position, or describes a state, which results in design loads being complied with under all conditions which are to be taken into account for the design of a wind power installation. Design loads refer to loads for which the wind power installation is designed. Therefore, these are loads for which the wind power installation is designed for all the conditions which are to be taken into account for the design of a wind power installation.

The safe position may also be a feathered position, and a feathered position may be a blade position in the range of 80° to 100°. However, it may also be a different blade position, e.g. one in which the trailing edge of one, a plurality, or all of the rotor blades point toward the wind. The rotor blade in question then thus adopts a blade angle of about 270°.

It therefore also comes into consideration that the rotor blades are moved into the feathered position and/or the rotor blades are first moved into a position of 80° to 100°, and in one example into a position of about 90°, and in one example by means of a predetermined trajectory. Then, that is to say after moving into the safe position, the feathered position and/or into the range of 80° to 100°, the wind power installation is brought into a coasting position.

This thus underlines that the wind power installation is stopped in the event of a safety stop and, according to a variant, it is also ensured that the rotor no longer rotates. For this purpose, it can be braked or be regeneratively held in position.

In one example, the rotor blades are moved into the feathered position for this purpose. They are thus turned so far out of the wind that they no longer generate aerodynamic torque and also offer the smallest possible contact surface for the wind.

In one example, one control strategy in the event of a safety stop can be that the rotor blades are first moved into a position of approximately 90°, in one example approximately into the feathered position. The installation can then stop there, as a result of which a safety aspect is realized. According to the control strategy, the rotor blades can then continue to be adjusted to the extent that the wind power installation is brought into a coasting position. The rotor blades can in addition be turned somewhat into the wind again, but only to the extent that the aerodynamic rotor only rotates very slowly, in one example at a speed of less than 10% of the rated speed, and in another example, of less than 5% of the rated speed.

Here it has been recognized that a low-load position can be achieved by such a coasting operation because the rotor blades or the rotor can thus partially yield to an acting force from the wind. Provision is made for the adjustment to also be carried out into the position of about 90° by means of a predetermined trajectory. In one example, as was explained further above, a pitch rate specified over time can be used as a basis. A pitch rate can also be specified via a blade angle such that a particular pitch rate is thus used depending on the existing or reached blade angle in each case.

These proposed strategies are also performed as a safety stop, that is to say not with the usual installation or operating controller.

According to one aspect, it is proposed that different target blade angles for the rotor blades are controlled using the control strategy. Although adjustment toward the feathered position can also be provided here, the rotor blades then do not reach the feathered position exactly and deviate from the latter to different extents. This thus ensures that not all the rotor blades have the same blade angle and this thus ensures that in the safety position reached, not all the rotor blades are suddenly exposed to a particular incident flow of the wind in a particular incident flow direction, which can lead to blade vibration. If the rotor blades are oriented differently, one rotor blade could thus experience an unfavorable incident flow situation but not all the rotor blades at the same time.

Alternatively, provision is made for a strategy in which the rotor blades are adjusted in terms of their blade angle such that they are adjusted to the same target blade angle should they have had different blade angles at the beginning of the safety stop. Provision is made here for a safe position for the wind power installation to have been determined, which safe position is designed to be as low-load as possible for all the rotor blades and also to avoid a situation in which the rotor blades are made to vibrate. If the blade angles of the rotor blades are now set differently at the beginning of the safety stop or should different blade angles have occurred during the performance of the safety stop, this can thus be adjusted here.

It is proposed that the adjustment is controlled so that it also counteracts the occurrence of different blade angles, so that it also counteracts the divergence of the blade angles. This can be achieved by monitoring all the blade angles and comparing them with their mean value. Depending on whether they are above or below the mean value, the pitch rate can be adapted accordingly to further compensate for this deviation.

According to one aspect, it is proposed that the wind power installation has an operating controller and a safety controller, and the safety stop is controlled by the safety controller and in one example the stopping of the rotor is controlled by the operating controller if there is no safety stop. A clear differentiation is thus made here between a safety controller and the operating controller. A safety controller has higher safety requirements than an operating controller. It may be distinguished by redundancies and/or by the fact that it complies with safety regula-tions. In one example, it may be certified as a safety controller.

Such a safety controller can be very complex due to possessing particular secured, partially redundant communication processes. Moreover, it may be powered by an uninterruptible power supply, to name one further feature. A safety controller is in fact known to the person skilled in the art, however, and they can clearly distinguish it from an operating controller.

The operating controller does not have to meet such a high level of safety and therefore all the processes in a wind power installation which do not require special safety control are controlled on the operating controller.

Based on this, it is proposed here that the stopping of the rotor is usually controlled by the operating controller, just like the speed of the rotor is also otherwise controlled by the operating controller, the adjustment of its rotor blades in terms of their blade angle is controlled by the operating controller and the generator is also controlled by the operating controller with regard to the desired power or the desired torque.

However, if a safety stop is intended, this is thus controlled by the safety controller. This also involves the safety controller being designed here to be able to perform a plurality of control strategies for performing the safety stop. The safety controller can thus select this plurality of control strategies or carry out corresponding settings or changes to a control strategy in order to thus be able to apply different control strategies for performing the safety stop. Accordingly, a plurality of control strategies can be implemented by the safety controller and the implementation of all these control strategies by the safety controller thus also meets all the criteria that a safety controller has to meet.

It has been recognized here that the safety controller can be trained to not only carry out a simplified sequence for a safety stop but also to be able to implement different strategies in a targeted manner. For this purpose, such a strategy can be implemented on an FPGA, which is then part of the safety controller. Other realizations also come into consideration, however.

According to one aspect, it is proposed that different trigger classes are provided for classifying possible trigger events, an occurring trigger event is assigned to one of the trigger classes, the control strategy is selected on the basis of the assigned trigger class, and a safety stop is assigned to one of the trigger classes, in one example at least three trigger classes being provided.

Classification is thus provided, which is further explained in more detail below, from which a selection is then made depending on the trigger event. The trigger event is thus assigned to a trigger class and clarity of use is achieved as a result, in one example by virtue of each trigger event being assigned to a trigger class. Whatever happens, it can thus be assigned to a trigger class, and it can then also be clearly assigned whether the trigger event is a safety stop or not. It is a safety stop namely when it is assigned to the corresponding trigger class of the safety stop, otherwise it is not a safety stop. A safety stop may be distinguished or defined by the fact that it is implemented on hardware specifically provided for the safety stop and/or using specifically provided software for the safety stop.

At least three trigger classes are provided, this underlining that in one example not just a single trigger class is provided and that the trigger events can thus actually be assigned to different classes, namely at least in three trigger classes.

In one example, the following trigger classes come into consideration.

According to one aspect, it is proposed that a safety stop is distinguished in that its trigger events are stored as safety-relevant trigger events and/or its trigger events, or some of them, are the violation of a safety limit value. The trigger events can be stored as software or as hardware, for example, such that corresponding criteria are provided, which are queried in the software or hardware and then lead to a trigger event being identified as a safety-relevant trigger event, this leading to the classification of a safety stop.

In one example, the following trigger classes are provided as trigger classes, one of which classifies the trigger events which are considered to be safety-relevant trigger events.

A first trigger class is one which may be referred to as a slow coasting stop and classifies the trigger events which trigger a stop of the installation into a coasting operation, the rotor blades being moved to a stop at a blade adjustment speed which has an average value below a specifiable first limit value.

A second trigger class is one which may be referred to as a fast coasting stop and classifies the trigger events which trigger a stop of the installation into a coasting operation, the rotor blades being moved to a stop at a blade adjustment speed which has an average value above the specifiable first limit value, in one example above a second limit value above the first limit value.

A fourth trigger class is one which triggers a safety stop and classifies the trigger events which are stored as safety-relevant trigger events and/or which occur when a sensor value violates a safety limit value.

A third trigger class is one which may be referred to as a complete stop and classifies the trigger events which trigger a stop of the installation to a standstill without falling under the fourth trigger class.

A plurality of trigger classes are thus proposed, but of which only one triggers a safety stop, of which only one thus belongs to safety-relevant trigger events.

According to one aspect, it is proposed that the trigger class which classifies trigger events for triggering a safety stop comprises a plurality of trigger events for triggering a safety stop. In addition, it is proposed that the plurality of trigger events are prioritized so that if a plurality of the trigger events which trigger a safety stop are present, the control strategy assigned to that one of the present trigger events which has the highest priority is used.

In one example, this is the fourth trigger class here. It contains a plurality of trigger events which are stored, one example, accordingly in software or otherwise. If a trigger event which is stored in this fourth trigger class occurs, a safety stop is always performed. Depending on which of these trigger events stored in the fourth trigger class occurs, the safety stop is performed in different ways.

If a plurality of trigger events from this fourth trigger class now occur, a plurality of ways in which the safety stop should be performed would be pitted against one another in the form of a possible conflict. To avoid this, the trigger events are prioritized in this fourth trigger class. If, for example, the second and fourth trigger criterion according to prioritization in this fourth trigger class occur, the safety stop takes place according to what is stored for the second trigger event. This thus clearly defines how the safety stop should be performed.

It has also been recognized in this case that even in the event of safety stops, different requirements may be present. For example, a slow safety stop can be used in the event of a network event, in one example a network failure, that is to say a failure of the electrical supply network, which may simplistically also be referred to as a network. Depending on wind conditions during the network failure, a high rotor acceleration and correspondingly high rotor speed may occur. If the rotor speed then exceeds an overspeed limit value of a corresponding safety controller for overspeed, this safety controller for overspeed is assigned a higher priority. A faster profile is then changed to, which profile is the basis namely for the safety controller for overspeed or is implemented in this safety controller for overspeed.

Additionally, or alternatively, it is proposed that the control strategy is changed over the course of the safety stop if at least one trigger event with a higher priority than the other present trigger events comes along or ceases to exist.

It has thus been recognized that a further trigger event which likewise triggers a safety stop can come along even during the performance of a safety stop. If this is of lower priority than the trigger event which leads to the triggering of the safety stop that has just been implemented, nothing changes. However, if this new trigger event has a higher priority, the strategy can thus be changed even while the method is ongoing.

An example has already been mentioned above, in which a network failure first triggers safety control, namely safety control for network failure, with a subsequent safety control for overspeed having a higher priority and therefore being changed to. In this case, during the performance of the safety stop, that is to say during the performance of the safety control for network failure, the control strategy is changed, namely by changing to the safety control for overspeed.

In this respect, the trigger events of this fourth trigger class are also prioritized for this, that is to say placed in an order and depending on this, the correspondingly assigned strategy for implementing the safety stop can be selected according to this prioritization. In one example, a clear assignment is achieved and a situation where a safety stop of highest priority is not performed because a safety stop of lower priority is currently being performed is avoided.

According to one aspect, provision is made for a pitch system to be present for adjusting the rotor blades, a default trajectory is stored in the pitch system and the default trajectory is used to adjust the rotor blades if the pitch system loses its communication link to the safety system, the adjustment of the rotor blades in the event of the safety stop otherwise being specified by the safety system instead of the use of the default trajectory.

In one example, instead of the default trajectory, the safety stop can then take place depending on a stored strategy. For this purpose, trajectories for adjusting the rotor blades, in one example trajectories corresponding to trigger events of the fourth trigger class, can be stored as part of the strategies.

The pitch system can include corresponding pitch drives, that is to say variable drives, for the rotor blades, which are controlled by a central sub-control unit of the pitch system.

Such a central sub-control unit is thus part of the pitch system and can be arranged there in an element of the aerodynamic rotor, in one example the rotor hub and/or the spinner.

In addition, there may be an emergency power supply which allows the rotor blades to be adjusted for a limited period of time even if an electrical power supply to the wind power installation, in one example to the pitch drives, has failed in another way. Such a pitch system can thus be designed autonomously, in any case for a temporally limited adjustment activity. The central sub-control unit can, for example, be designed as an FPGA.

If an error which leads to a safety stop occurs, the appropriate strategy for performing this safety stop is in principle searched for, namely one being selected from the stored strategies depending on the trigger event. All of this can be implemented on the safety system which may be part of the installation controller or may be overlaid on it. These strategies can thus be stored there. The blade adjustment is then controlled by this safety system or the installation controller via the pitch system. In this case, the correspondingly selected strategy is thus transmitted and implemented.

However, if the communication between the pitch system and the safety system fails, the desired strategy can thus no longer be selected and transmitted to the pitch system.

In this case, the default trajectory is used. Such a default trajectory may also synonymously be referred to as an emergency trajectory or trajectory for communication failure or simply standard trajectory. This standard trajectory is thus stored, namely in the pitch system, and can be selected if the communication link fails. This ensures that a safety stop can always be performed, even if not necessarily with the most appropriate trajectory.

According to one aspect, it is proposed that a safety stop is only triggered on the basis of a signal which meets at least one predetermined safety criterion and may be referred to as a safety signal, in one example the safety signal being performed redundantly and/or being certified as a safety signal.

In one example, a safety stop should not be triggered by a false trigger. All trigger events which lead to a safety stop are preferably stored or implemented in a safety system which has to meet more stringent criteria with regard to safety compared to the usual installation controller. Such criteria include the use of components having high fail-safety, the implementation of safety checks which prevent malfunctions, and also the generation and forwarding of safety signals which are transmitted via appropriate safety connections which prevent signal transmission interference and are fail-safe protected. In one example, one criterion is that transmission between at least one transmitter and a receiver is realized such that the receiver recog-nizes if the at least one transmitter has failed. Such a recognized failure then leads to a safety stop. Preferably, provision can be made for such a failure to trigger the safety stop only after a predetermined tolerance time after said failure has been recognized. Such a tolerance time can be defined by a predetermined number of communication intervals.

A safety stop is thus only triggered by such safety signals and this underlines that such a safety stop meets more stringent requirements compared to other stopping operations of the wind power installation.

According to one aspect, it is proposed that the trigger events which trigger the safety stop are selected from the list comprising:
a speed exceeds a predetermined limit speed which, in one example if it is exceeded, indicates a sensor error,
a tower vibration and/or tower acceleration exceeds a predetermined tower vibration limit value or a predetermined tower acceleration limit value,
a blade angle difference between two of the rotor blades exceeds a predetermined differential angle limit value,
the blade angle of at least one rotor blade falls below a predetermined minimum blade angle,
an emergency stop switch is actuated,
a generator vibration is above a predetermined generator vibration limit value,
a network error occurs, and/or a network disconnection,
a detected pitch rate deviates from a pitch rate that is to be expected based on a detected rotor speed by more than a predetermined maximum deviation rate,
a detected rotor blade vibration exceeds a predetermined limit value, and
a detected oblique incident flow exceeds a predetermined oblique incident flow measurement.

In the case of the trigger criterion that the detected pitch rate deviates from the expected pitch rate by more than the predetermined maximum deviation rate, the following should be explained. This trigger criterion is based on a safety function which checks the plausibility of the actual pitch rate on the basis of the rotor velocity, which may synonymously be referred to as the rotor speed, that is to say checks whether the pitch rate is plausible in the light of the rotor speed. For example, a safety stop is triggered if, at a high speed, which in one example is above the rated speed, the pitch is yet even further forward, that is to say into the wind, which would lead to a further increase in the rotor speed. In this case, the predetermined maximum deviation rate can be dynamically predetermined and depend on the specific situation.

According to one aspect, it is proposed that if the trigger event triggers a safety stop, the trigger event is identified and a temporal pitch rate profile is selected or set on the basis of the identified trigger event. In addition, or alternatively, a temporal generator profile is selected or set on the basis of the identified trigger event, the temporal generator profile designating a temporal curve of a generator torque or of a generator power.

The temporal pitch rate profile and/or the temporal generator profile can be selected from correspondingly stored pitch rate profiles or generator profiles. However, setting can also be carried out by setting or adjusting a parameter, for example, this possibly applying to both the pitch rate profile and the generator profile. Such a parameter may, for example, be an adjustment rate, or there may be a plurality of parameters which indicate basic points of a profile.

The selecting is performed on the basis of the identified trigger event. For this purpose, the trigger event can be one of a plurality from the fourth trigger class. A temporal pitch rate profile can be used to define how quickly the rotor blades are adjusted, this also including how quickly the rotor blades are accelerated and slowed back to the target value during adjustment.

It has additionally been recognized that owing to the adjustment of the rotor blades, in one example on the basis of the pitch rate profile, the expected change in the aerodynamic rotor torque caused by the wind is known or can be determined. The control of the generator can be adapted to this accordingly in order to achieve a speed reduction or not to prevent it.

For example, provision can be made to specify a maximum torque, a different characteristic curve, in one example speed-torque characteristic curve, and/or ramp for the torque. In the event of errors in the electrical system or load shedding, a different temporal profile for the generator torque can be specified. In one example, it is proposed to set the generator torque accordingly via a temporal generator profile since this can be adapted to the aerodynamic rotor torque to which the generator torque is opposed. However, depending on the control implemented, it also comes into consideration that instead of specifying a curve of the generator torque, a curve of a generator power is specified. But even then this is ultimately based on the change in the generator torque and thus also on a temporal curve of a generator torque, even if this is not expressly defined.

According to one aspect, it is proposed that the stopping of the rotor by the safety stop is controlled such that one or more predetermined load limits are not exceeded, but in one example reached, or reached to at least 90%. In one example, it is proposed that the rotor is stopped such that the installation is close to such load limits. The safety stop can thus be performed as quickly as possible but only so quickly that no mechanical damage or excessive mechanical stress occurs.

In one example, the load limits are selected from at least one of the following loads. These loads include a maximum blade load on the rotor blades, a maximum blade vibration amplitude, that is to say also of the rotor blades, a maximum tower bend, a maximum tower vibration amplitude, a maximum tower acceleration, and a maximum rotor shaft bend or axle journal bend of an axle journal carrying the rotor.

Provision is thus made, in one example, for detecting such loads and controlling the safety stop on the basis thereof, in particular such that the installation is close to corresponding loads, as short as possible below corresponding load limits.

However, it also comes into consideration that the corresponding loads are predetermined based on pre-calculations and/or pre-simulations which can be carried out before the wind power installation is put into operation. For example, at a particular wind speed, optionally taking into account turbulence and other variations in the wind speed, a corresponding load can thus be determined or be known. This load changes while the safety stop is being carried out, in one example while the blade angles of the rotor blades are being changed. By way of appropriate preliminary examinations or preliminary simulations, in this case it is also possible to predetermine how the loads change as the blade angle and/or rotor speed change and, based on this, it is possible to plan a safety stop in which the said loads are still being complied with.

In one example, it is possible to predetermine a load profile from the adjustment of the rotor blades and/or of the rotor speed together with the prevailing wind, and the adjustment of the rotor blades and/or of the rotor speed, which can also be influenced using the generator torque or the generator power, are adapted such that the loads are being complied with. If the result of a simulation is thus that a load is being exceeded for a particular portion of the initially selected trajectory for adjusting the rotor blades, this trajectory is adapted accordingly. The same applies if the loads are significantly fallen below, such that such an adaptation can then be carried out that the loads can be further increased, this involving an acceleration of the method.

According to one aspect, it is proposed that the controlling of the safety stop by the safety system is integrated into a controller so that the stopping of the rotor, in particular adjustment of the rotor blades and/or the controlling of a generator torque or of a generator power, is performed on the basis of at least one detected or estimated load such that this at least one load complies with a predetermined load limit value at all times. The detection and thus feeding back of a load is therefore expressly proposed. The load can thus be complied with and at the same time the safety stop can also be performed such that the installation is close to the respective load limit. A large safety distance thus does not need to be complied with for the purpose of taking uncertainties into account, since the respective load is detected.

It has been recognized that such a regulation can also be realized for the safety stop and in one example in a safety controller.

The load can be detected, for example, by measuring the load by using corresponding load sensors. In one example, strain gauges at the root of the blade come into consideration for this purpose. Detection without direct measurement of a load can be performed, for example, by evaluating the speed, in one example, by evaluating accelerations in the speed. Acceleration sensors, such as a gyroscope, can also be used.

According to one aspect, it is proposed that the safety procedure for performing the safety stop is performed, in one example, is performed redundantly, such that the safety stop can be performed by the safety system even in the event that the operating controller fails. This is, in one example, characteristic of a safety stop compared to other stopping operations of the wind power installation. Provision is thus made to perform the safety stop in this fail-safe manner but with different trigger events for the safety stops being taken into account at the same time and an appropriate safety stop being performed accordingly. Different strategies can thus be performed despite the safety criteria being taken into account.

Additionally, or alternatively, it is proposed that the safety system is certified to safely control a safety stop even in the event that the operating controller fails. Such certifications qualify a safety system as such and thus the safety stop as such. Here, too, provision is made to be able to apply different strategies in the event of a safety stop despite such a certification.

Additionally, or alternatively, provision is made for the safety system to be superordinate to the operating controller such that the safety system monitors the operating controller. It has been recognized here that most control operations of the wind power installation operate on the operating system. Special safety considerations lead to a safety system being overlaid on the operating controller, that is to say in this respect the normal operating controller which does not have to have any special safety features. Such a safety system, which is overlaid on the operating controller, can in one example recognize errors and failures and then initiate any emergency measures and also generate corresponding warning signals.

For such a safety system, it is proposed that it performs the safety stop and in doing so can also realize different strategies depending on the trigger event. The safety system which can apply different strategies for the safety stop is thus used for the safety stop.

According to one aspect, it is proposed that the control strategy is additionally selected on the basis of at least one operating state of the wind power installation at the time of the trigger event. Optionally, it is proposed that the control strategy is adapted during the control of the safety stop, in one example on the basis of at least one continuously detected operating state.

It has been recognized here that not just the trigger event, that is to say the error, which necessitates a safety stop, may be important for the way the safety stop is performed. In one example, an operating state on the basis of which the control strategy is additionally selected or adapted comprises the current speed and/or the currently set blade angles. On the basis of the speed, the rotor blade angles and/or the generator torque, alternatively the generator power, can be controlled such that the rotor speed is reduced as quickly as possible, in one example depending on the trigger event, that is to say depending on the error, which leads to the performance of the safety stop. If the speed is already low, the blade angles and/or the generator torque or the generator power can be controlled differently than when the speed were still high.

The currently set blade angles are also relevant. It should be noted here that the blade angles can be adjusted via an adjustment rate and this adjustment rate can be selected on the basis of the initial blade angle and then further controlled.

Consideration of a current installation power or generator power can also be used to select or set the control strategy. In this respect, it should be repeated that the selection of the control strategy may also relate to the setting thereof. Thus, it does not have to be retrieved from a memory as a fully implemented control strategy but rather it may also come into consideration that only concrete parameters are set in order to thus obtain variation in the control strategy and thus different control strategies. In any case, the initial generator power, which is thus present at the moment the trigger event occurs, may be relevant for carrying out the safety stop because the higher the installation power at that moment, the more power that may then have to be dissipated.

In this respect, it is also relevant here to take this into consideration in combination with the trigger event. If the trigger event is a loss of the electrical supply network, the electrical power cannot be fed in and is to be dissipated elsewhere so that in this case, the procedure is different than if the electrical supply network were still available during the performance of the safety stop, to give just one example.

In one example, the control strategy can also be adapted during the ongoing process, that is to say when the wind power installation is shut down as part of the safety stop. While the control strategy should be preplanned as much as possible from the outset until the installation has completely stopped, changes or variations may occur which are preferably taken into consideration. One variation may be that the initially still present electrical supply network can absorb power; however, if this possibility no longer exists during the ongoing safety stop, for example because safety switches disconnect the connection, the control strategy can be adapted.

Variations in the wind can also result in, in one example, the speed reduction provided in accordance with the control strategy being different than preplanned. The loads can also vary depending on the wind, not just the wind speed but also turbulence, and can then be taken into consideration by adapting the control strategy.

According to one aspect, it is proposed that the safety system for controlling the safety stop has and thus uses a microcontroller certified for a safety system and/or communication hardware certified for a safety system. Such microcontrollers, which are also referred to in the industry as safe microcontrollers, and also corresponding communication hardware, which is also referred to in the industry as safe communication hardware, should be used here. Such a certified microcontroller is, in one example, distinguished in that it has reduced susceptibility to errors compared with normal microcontrollers and this can be ensured one example by appropriate certification and/or by redundant performance during which a started process can still be performed to the end in the event of an error.

The same applies to the communication hardware, which can also be distinguished by redundancy. Communication hardware can also include corresponding interference-free cables as well as secure, in one example redundant, hardware which is used to control the communication.

An FPGA (Field-Programmable Gate Array) can be used as a microcontroller, for example.

The disclosure also proposes a wind power installation,
the wind power installation having an aerodynamic rotor with rotor blades which are able to be adjusted in terms of their blade angle, and
the rotor being able to be operated at a variable rotor speed, the wind power installation being set up such that
the rotor blades are moved toward a feathered position in order to stop the rotor,
the stopping is triggered by a trigger event and
if a safety stop is triggered on the basis of the trigger event, one of a plurality of control strategies for performing the safety stop is additionally selected on the basis of the trigger event.

In one example, it is proposed that the wind power installation has an installation controller, and that the wind power installation, in one example, this installation controller, is set up to perform a method according to one of the aspects explained above. The wind power installation may be set up to perform such methods that these methods are implemented on the installation controller. In this case, the installation controller may also comprise a plurality of units, including units distributed in the wind power installation.

In one example, the installation controller has an operating controller and a safety controller overlaid on the operating controller. The operating controller is, in one example, provided to control the wind power installation during ongoing operation. The safety controller is used to perform a safety stop. In one example, the safety controller is certified as such.

The disclosure is explained in more detail below by way of example with reference to the accompanying figures.

### BRIEF DESCRIPTION OF THE DRAWINGS

FIG. 1 illustrates a wind power installation in a perspective illustration.

FIGS. 2-5 illustrate time diagrams for different stopping operations for stopping a wind power installation.

FIG. 6 illustrates time diagrams for two different safety stopping operations.

FIG. 7 schematically illustrates an installation controller having an operating controller and having a safety controller overlaid on this installation controller.

### DETAILED DESCRIPTION

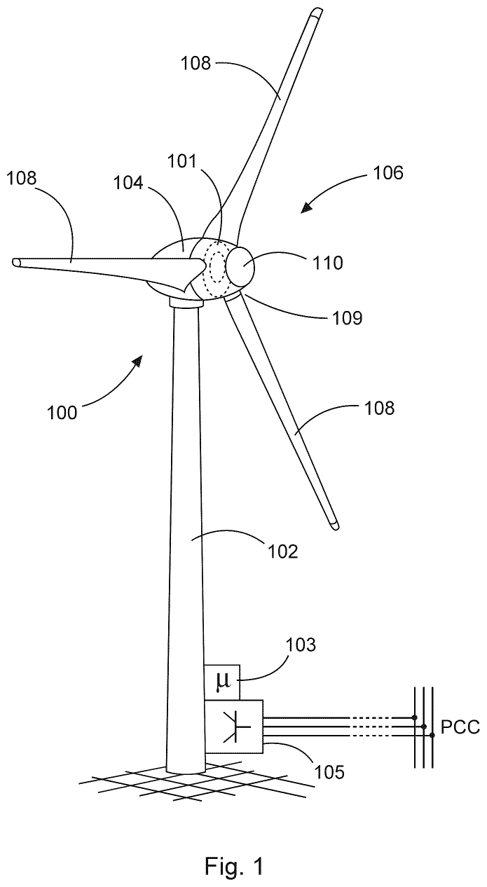

FIG. 1 illustrates a schematic illustration of a wind power installation according to the disclosure. The wind power installation 100 has a tower 102 and a nacelle 104 on the tower 102. An aerodynamic rotor 106 with three rotor blades 108 and a spinner 110 is provided on the nacelle 104. During operation of the wind power installation, the aerodynamic rotor 106 is set in rotation by the wind and thus also turns an electrodynamic rotor of a generator, which is coupled directly or indirectly to the aerodynamic rotor 106. The electric generator is arranged in the nacelle 104 and generates electrical energy. The pitch angles of the rotor blades 108 are able to be changed by pitch motors at the rotor blade roots 109 of the respective rotor blades 108.

The wind power installation 100 has an electric generator 101 here, which is indicated in the nacelle 104. The generator 101 may be used to generate electrical power. A feeding-in unit 105, which may be designed as an inverter, is provided for the purpose of feeding in electrical power. It is therefore possible to generate a three-phase infeed current and/or a three-phase infeed voltage, according to amplitude, frequency and phase, for feeding in at a grid connection point PCC. This may be done directly or together with other wind power installations in a wind farm. An installation controller 103 is provided for the purpose of controlling the wind power installation 100 and also the feeding-in unit 105. The installation controller 103 may also receive target values from external sources, in one example from a central farm computer.

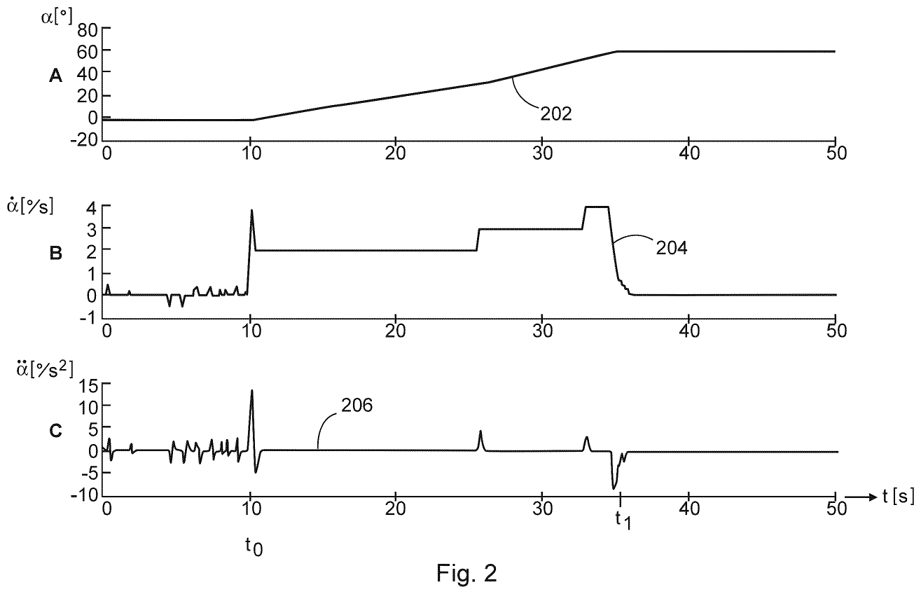

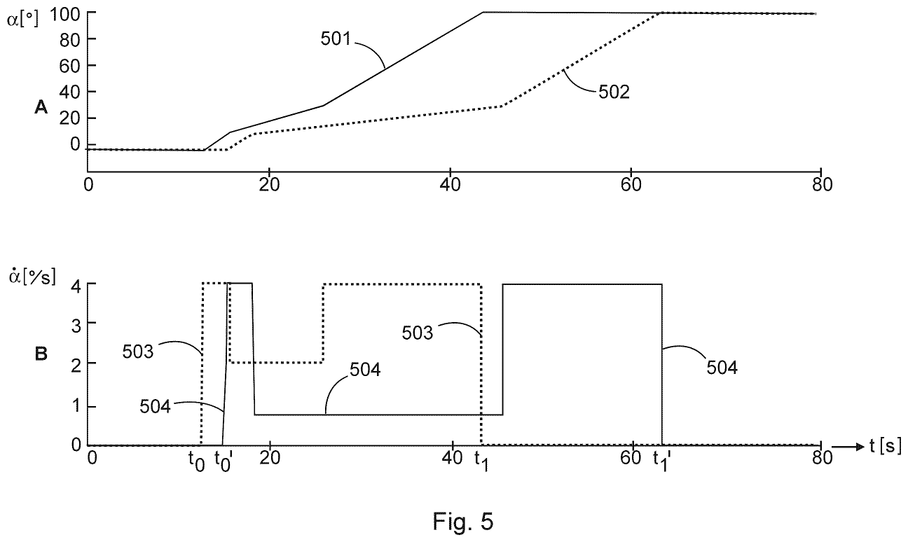

FIGS. 2 to 5 illustrate a blade angle diagram A as the uppermost diagram, in which a blade angle curve 202 is illustrated, and a pitch rate diagram B as the second diagram from the top, in which a pitch rate curve 204 is illustrated. In FIGS. 2 to 4, an acceleration diagram C is also additionally illustrated as a third diagram, in which an acceleration curve 206 of the acceleration of the blade angles is illustrated. Only in FIG. 5 is the acceleration diagram missing. The reference signs of the blade angle curve 202, of the pitch rate curve 204 and of the acceleration curve 206 are selected to be the same in order to better compare FIGS. 2 to 5, although different curves are illustrated of course.

FIG. 2 in this case illustrates a standard stopping operation, which may also be referred to as a “standard stop” stopping procedure. In this case, the wind power installation is brought into actively regulated coasting operation. At time t₀, the stopping operation starts and has basically reached its target at time t₁, the installation then being kept in coasting operation.

At time t₀, the blade angle is thus increased from about 0° to about 60°, which it reaches at t₁.

In the pitch rate diagram B of FIG. 2 it can be seen that the adjustment rate increases over the course of the stopping operation. The adjustment rate is highest shortly before the target time t₁ is reached. In the acceleration diagram C, it can be seen that the acceleration curve 206 has peaks in each case when the blade adjustment rate changes abruptly.

According to the standard stop of FIG. 2, the wind power installation is thus brought into the actively regulated coasting operation by virtue of the blade angle having 60° or more. During active coasting operation, the rotor rotates at low speed, which can reach a maximum coasting speed, depending on the wind speed, or the rotor stands still in complete wind stillness. The active coasting operation allows the wind power installations to be kept in a state in a gentle manner in order to be able to restart them quickly. The maximum coasting speed is able to be parametrized in the installation controller. If the wind power installation, that is to say the rotor speed, exceeds the coasting speed, the blades are retracted, that is to say moved further toward the feathered position.

Such a standard stop does not need to be executed as a safety stop and also does not need to be implemented in a safety controller.

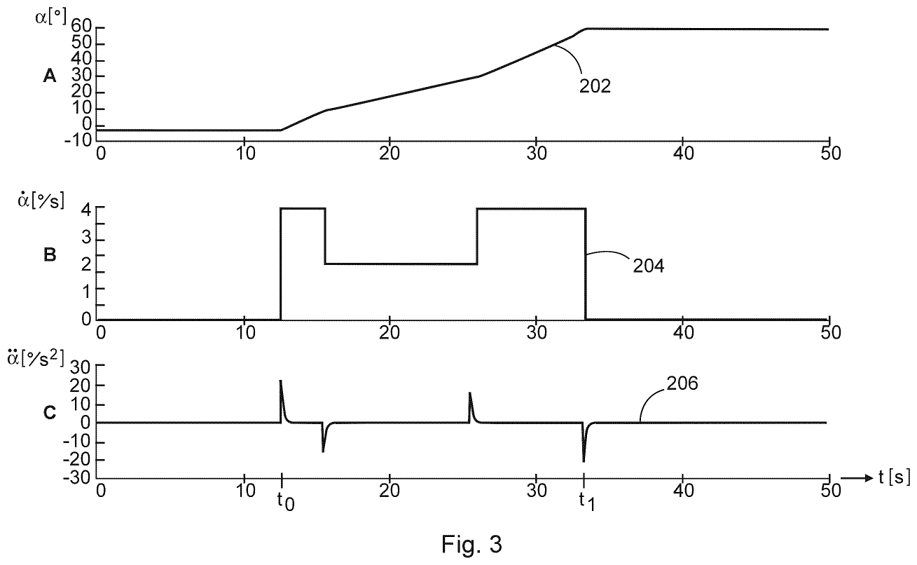

FIG. 3 illustrates a fast stopping operation, which may also be referred to as a “fast stop” stopping procedure. This fast installation stop also stops the wind power installation during the active coasting operation. Compared to the standard stop according to FIG. 2, the blade adjustment takes place at an increased speed. In one example, in the pitch rate curve diagram B, it can be seen on the pitch rate curve 204 that the blade adjustment rate initially jumps to a high value at time t₀ when the fast installation stop is started. After some time, it may fall off slightly in order to avoid excessive stress. Toward target time t₁, the pitch rate can assume a high value again, as can be gathered from the pitch rate curve 204. The blade angle changes correspondingly quickly according to the blade angle curve 202 from a value of about 0° to a value of about 60°.

In the acceleration curve 206, the changes between the different blade adjustment rates can be recognized by corresponding peaks.

Also in the fast stopping operation according to FIG. 3, the rotor in the active coasting operation rotates at low speed up to a maximum coasting speed, depending on the wind speed, or stands still in complete wind stillness.

The fast stopping operation according to FIG. 3 likewise does not need to be implemented on a safety controller and thus also does not need to be executed as a safety stop.

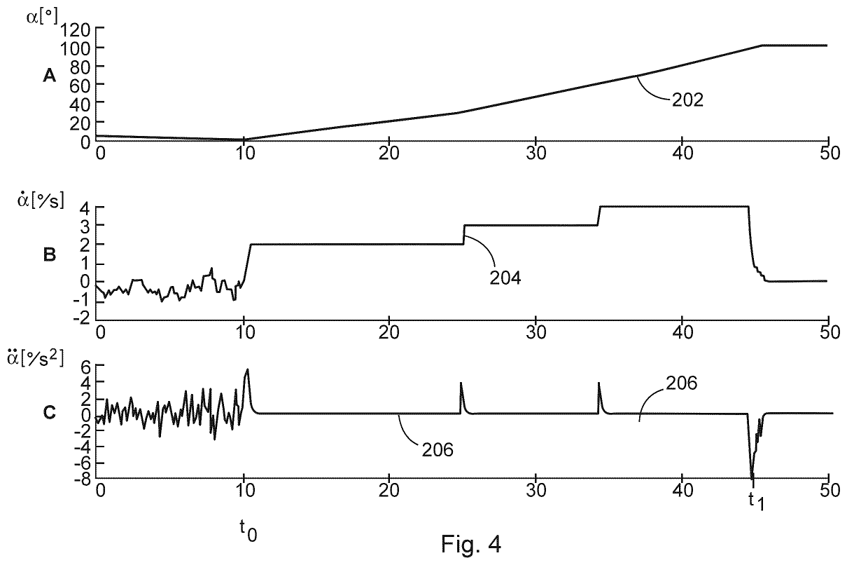

FIG. 4 illustrates a complete stop, which may also be referred to as a “full stop” stopping procedure. This complete stopping procedure stops the wind power installation in the feathered position. In the feathered position, the rotor blades do not produce any lift even in wind and the rotor stands still or moves only very slightly. The feathered position may depend on the installation type, that is to say on the type of the wind power installation, and is in the range between 90° and 100°.

FIG. 4 in this case illustrates that the blade angle curve increases from about 0° starting at the start time t₀ and reaches the value of about 100° at the target time t₁. The blade angle curve 202 shows that the blade angle increases more over time and, in addition, it can be seen in the pitch rate curve 204 that the pitch rate increases in several stages so that the blade angle is moved toward the feathered position fastest toward the end.

In the acceleration curve 206, corresponding peaks can be recognized at the stages of the pitch rate curve 204.

Also this complete stopping operation does not need to be executed as a safety stop and thus also does not need to be implemented on a safety controller.

FIG. 5 illustrates two possible variants for executing a safety stop, yet further variants being possible. Two variants are shown as examples, namely a standard safety stop with a standard blade angle curve 501 and, in the event of a network error, a network error safety stop with a network error blade angle curve 502. A standard pitch rate curve 503 and a network error pitch rate curve 504 are correspondingly assigned thereto, which is shown in the second diagram of FIG. 5. It can be seen here that the standard blade angle curve 501 reaches the final value of about 100° faster than the network error blade angle curve 502.

The standard safety stop can be used if there is no distinction between different circum-stances for a safety stop. In this respect, the standard safety stop also reflects a previous solution. However, it has been recognized that even in the event of a safety stop, the wind power installation does not always have to be moved as quickly as with the standard safety stop. In the event of a network event, which may also be referred to as a network error, the response may be for example as shown by the network error blade angle curve 502 and the network error pitch rate curve 504. The response is still sufficiently fast but reduces loads which occur in this case.

Provision may also be made for the standard safety stop to be executed whenever the installation is to be stopped as quickly as possible, in one example, when an error occurs in which the blade angle leaves its current value significantly without reason, that is to say when the blade angle runs away, this also being referred to as “pitch runaway”. The standard curve also comes into consideration when a tower vibration above a predetermined tower vibration value has been detected or when an overspeed during which the rotor speed is above a predetermined limit speed has been detected. However, the standard safety stop can also be used when the error could not be identified. This fast stopping operation is then also selected as standard.

For errors which require a response that is not all too fast, the network error curve 502 can be used. Such a curve or such a stopping operation is always proposed when a network error occurs, that is to say when the network has a predetermined error, such as, e.g., where the network frequency exceeds a predetermined upper frequency limit value or falls below a predetermined lower frequency limit value. The wind power installation losing contact with the network, for example because a network disconnect switch has disconnected a connection, can also be regarded as a network error.

To improve the illustration, the start times of the two stopping operations are selected or illustrated slightly offset such that there is a first start time t₀ for the standard safety stop and a second start time t₀′ for the stopping operation in the event of a network error.

Additionally, the standard blade angle curve 501 reaches its target time, namely the first target time t₁, much earlier, whereas the network error blade angle curve 502 reaches the blade angle of about 100° only at the second target time t₁′.

In one example, it can be seen that with the standard safety stop the standard blade angle curve 501 increases quite strongly and quickly, whereas the network error blade angle curve 502 is initially also adjusted quickly but then has a long period of very slow adjustment. The network error pitch rate 504 is also correspondingly low here. In one example, a quick start is initially made in order to turn the rotor blades out of the wind slightly so that less wind power can be captured by the rotor blades. However, the installation can then be stopped slightly more slowly, this also possibly leading to lower mechanical loads. The pitch rate diagram B shows the corresponding pitch curves 503 and 504, respectively, for this.

According to this safety stop, which may also be referred to as the “safety stop” stopping procedure, the wind power installation is stopped in the feathered position.

In the feathered position, the rotor blades do not produce any lift even in wind; the rotor stands still or moves very slightly. The feathered position here also depends on the installation type and can be between 90° and 100°.

In contrast to the other stopping procedures which were explained in FIGS. 2 to 4, these safety stops are considered to have been successfully completed if the safety controller is not carrying out an active stopping procedure and the conditions for a successful complete stop are met. This, in one example, includes the fact that the feathered position has been reached.

Here it is proposed that the safety stop is executed by the pitch system as profiled emergency running.

Such profiled emergency running thus has different profiles, as sketched in FIG. 5, and these profiles can differ based on the trigger reason and are specified by the safety system. Trigger reasons are set for the runtime using the sensors available to the safety system. The rotor speed can be evaluated for this purpose, for example.

The profiles can have different ramps, as shown in the blade angle diagram A of FIG. 5.

In the example, the ramps and thus the pitch rates can be switched at predetermined blade angles, which for example are at 9° and 30° in FIG. 5, and shut down independently by the pitch system.

All of this, as explained in FIG. 5, is implemented in a safety system. It has thus been recognized that different profiles can also be run in the event of a safety stop implemented in a safety system. As a result, different errors can be reacted to differently despite the implementation in the safety system.

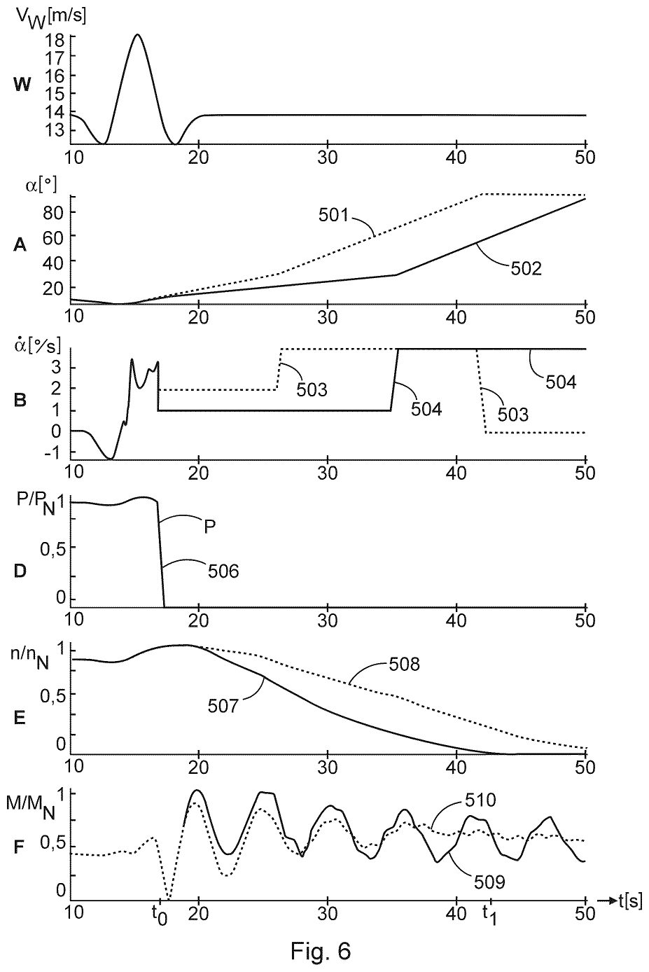

FIG. 6 explains the two variants of the safety stops according to FIG. 5 with greater details. For this purpose, FIG. 6 shows six individual time diagrams, starting from the top with diagram W which illustrates the curve of a wind speed as a possible reason for triggering one of the two safety stops.

Diagram W shows the curve of the wind speed 500, which shows a typical curve of a gust. First, the wind speed drops slightly, which leads to the rotor blades being reduced in terms of their blade angle. The wind speed then rises sharply and in doing so reaches blade angles which are very low. It is customary to use such a situation as a basis for load simulation and to additionally assume, for the purpose of the test, that such a very strong gust also triggers a network event. In the present case, this network event is thus the trigger event which triggers the safety stop.

A network event or network error which occurs shortly before to thus then leads to the initiation of the safety stop. In this respect, the network error safety stop is therefore triggered by the curves 502, 504, 508 and 510. For comparison, a standard safety stop according to the curves 501, 503, 507 and 509 is shown, which was likewise triggered at time t₀.

Diagrams A and B basically correspond to diagrams A and B of FIG. 5. However, the pitch rate diagram B of FIG. 6 does not provide an offset start time t₀ but rather allows both safety stops to begin at the same start time t₀. The faster of the two safety stops, namely the standard safety stop, ends at the target time t₁. The end of the slower safety stop, that is to say the network error safety stop, is outside the time frame of the diagrams of FIG. 6. For the blade angle curve diagram A and the pitch rate curve diagram B, the same reference signs as provided in FIG. 5 are provided, namely a standard blade angle curve 501, a network error blade angle curve 502, a standard pitch rate curve 503 and a network error pitch rate curve 504.

The curves of these two diagrams are already explained in connection with FIG. 5 to which reference is made here.

Furthermore, diagram D shows a curve of the generated power and thus a power curve 506. It can be seen that shortly after the start time, after a first blade adjustment has taken place, which is still identical for both variants of the safety stops shown, the power is reduced from the value before the error to zero. The wind power installation thus no longer generates power.

Also shown is diagram E which shows the curve of the rotor speed and thus the standard speed curve 507 and the network error speed curve 508. It can be seen that the speed drops also faster according to the standard speed curve 507, that is to say for the faster of the two safety stops. The network error speed curve 508 drops correspondingly more slowly. In both cases, however, the speed drops to zero because the installation comes to a standstill.

Diagram F shows the curve of the tower bending torque and it can be recognized that it initially drops to zero together with the power drop. The bending torque then rises again and vibrations which subside more quickly in the case of the network error tower torque curve 510 can then be recognized. Diagram F thus shows a standard tower torque curve 509 and a network error tower torque curve 510.

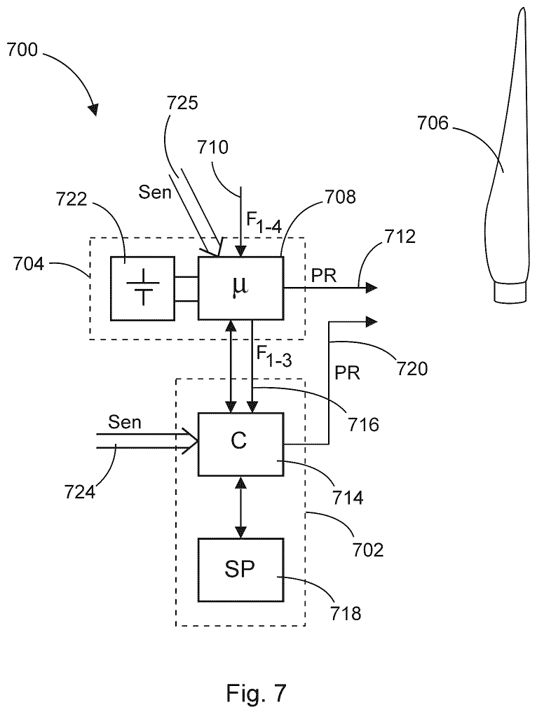

FIG. 7 schematically shows an installation controller 700 which is only shown very schematically and also only shows a few selected functionalities. This installation controller has an operating controller 702 which is overlaid by a safety controller 704. A rotor blade 706 is shown by way of example, which rotor blade can be controlled using pitch rates PR.

In the event of an error F, the processor 708 of the safety controller receives said error as a trigger event 710. The latter can be evaluated in the processor 708 which may be designed as an FPGA, for example. If the trigger event belongs to the fourth trigger class which triggers a safety stop, the processor 708 and thus the safety controller 704 is thus activated immediately and outputs a safety pitch rate 712 which leads to the adjustment of the blade angle of the rotor blade 706.

In this respect, the error which is received as the trigger event 710 may initially be one of four trigger classes, four trigger classes being mentioned by way of example, and is therefore given the symbol F₁₋₄.

However, if the trigger event is not one which is intended to trigger a safety stop, the processor 708 and thus the safety controller 704 can pass the trigger event to the operating controller 702. This is indicated by the errors F₁₋₃ which are entered into the process computer 714 of the operating controller. This process computer 714 can then carry out further evaluation based on the received trigger events which in this respect do not form safety stop trigger events 716. For this purpose, the process computer 714 can communicate with a data memory 718 in order to then select the appropriate stopping procedure. The result of the evaluation can then also be a pitch rate, but a normal pitch rate 720.

A stopping operation can thus be executed in different ways, either as a safety stop by the processor 708 of the safety controller 704, or as a non-safety stop by the process computer 714 of the operating controller 702. The safety controller 704 is in this respect, as explained, superordinate to the operating controller 702.

The safety controller 704 has to meet various criteria, and in one example, be certified as a safety controller, and this is also intended to be symbolically illustrated by the battery storage unit 720 which ensures that the safety controller 704 can operate safely even in the event of a network failure. The safety controller 704 thus has a redundant power supply.

The operating controller 702 does not need such a safety standard. However, the operating controller 702 is intended to execute a large number of tasks, in simplified terms all those which are not directly executed in the safety controller 704. By way of example, it is additionally also indicated for the purpose of symbolization that the operating controller 702, in one example the process computer 714, receives various sensor data 724 for operating the wind power installation.

Insofar as sensor data are required for detecting, triggering or carrying out a safety stop, the safety controller 704, in one example the processor 708 thereof, receives sensor data 725 itself and directly. This prevents sensor data from being transmitted via the operating controller, which could impede the execution of a safety stop in the event of an error, this being avoided by virtue of the sensor data 725 being fed in directly.

Furthermore, the following is to be explained about the disclosure, not limited to specific embodiments.

The turbine, which is synonymous with wind power installation, can carry out different stopping procedures on the basis of the event which leads to the stopping of the turbine. The procedure may comprise the profile for the pitch system which is used to bring the rotor blades, which may simplistically and synonymously also be referred to as blades, into the feathered position. The procedure may also comprise controlling the generator torque during the stopping procedure. The stopping procedures can be distinguished on the basis of the hardware unit which controls the stop. Based on the event or error which has occurred and the hardware unit which controls the stop, it is possible to prioritize the present stopping procedures, the safety stop being the stopping procedure with the highest priority.

During the design process for designing the wind power installation, it has to be ensured that the design loads are not exceeded by any of the stopping procedures. This is ensured by virtue of each pitch rate being limited to the pitch rate of the safety stop of the corresponding blade angle.

The presence of a plurality of stopping procedures in the operating controller has been industry standard for several years, but up to now the safety stop has only consisted of a single stopping procedure.

The proposed disclosure involves dynamic selection of the stopping procedure carried out by the safety system, on the basis of the type of error and the current working conditions.

The selection, in one example dynamic selection, comprises:
the choice of the controlled pitch rate at a particular pitch angle
the setpoint value for the torque of the generator.

Due to the outlined priority system of the stopping procedures, the safety system has to decide on the stopping procedure in order to ensure the design loads. The number of safety stopping procedures is not limited to 2 but rather may also be higher. The selection of the stopping procedure is also not limited to the beginning of the stop but rather can also be switched or even dynamically adapted, e.g. by applying a factor which is based on predefined sets of rules.

An exemplary application is an FRT event (see FIG. 6). Previously, in the event of a network failure, the turbine carries out a fast stop 501, 503, 507 and 509, controlled by the operating controller, which has the same pitch profile as the standard safety stop 502, 504, 508 and 510 which is optimized for load balancing between tower, machine and blade by other failure scenarios. Reducing the pitch rate between 9° and 30° pitch angles reduces the resulting tower bending torque due to the higher thrust 509 which dampens the tower as it moves forward. Switching to the secondary pitch profile is related to an FRT event which has to be detected by the safety system.

In order to ensure a safe stopping procedure, an additional selection criterion which is based on the current operating conditions of the turbine is proposed. The reduced pitch rate leads to higher aerodynamic power due to the lower pitch angle. Depending on wind conditions, this may lead to critical overspeeds, in one example, if the lack of generator torque due to network failures and the limited chopper power are taken into account. The selection of the pitch profile therefore involves monitoring the current rotor speed and rotor acceleration. If a particular speed threshold value is exceeded and the rotor acceleration is still positive, the safety system has to switch to the standard (faster) stopping procedure in order to avoid critical overspeeds. This standard (faster) stopping procedure is shown by the curves 501, 503, 507 and 509.

Another option would be to implement feedback control during the stopping procedures on the basis of present reliable measurements, including tower acceleration sensors and rotor speed measurements. It is proposed that the entire selection process is implemented fully in the safety software with a certified performance level.

1. A method for controlling a wind power installation, the method comprising:
detecting a triggering event in relation to operation of the wind power installation;
determining if a safety stop is triggered based on the triggering event;
selecting one of a plurality of control strategies for implementation of the safety stop; and
stopping the operation of the wind power installation based on the one of the plurality of control strategies selected, wherein
the wind power installation has an aerodynamic rotor with rotor blades each having an adjustable blade angle, and
the aerodynamic rotor is operable at a variable rotor speed, and
the rotor blades are moved toward a feathered position for stopping the operation of the wind power installation.

2. The method as claimed in claim 1, wherein
each of the plurality of control strategies is based on a trajectory;
characterized by a pitch rate curve and a target blade angle,
each of the plurality of control strategies is associated with at least one of a generator power or a generator torque, or
the trajectory is characterized by pitch rate over time.

3. The method as claimed in claim 1, wherein during the safety stop,
the aerodynamic rotor does not rotate and is in a safe position,
the rotor blades are moved into the feathered position, or
the rotor blades are first moved into a position of about 90° via a predetermined trajectory, followed by the wind power installation brought to a coasting position.

4. The method as claimed in claim 1, wherein
different target blade angles for the rotor blades are controlled using the one of the plurality of control strategies, or
the rotor blades are adjusted to have the same target blade angle irrespective of starting angle at the beginning of the safety stop, or during the performance of the safety stop.

5. The method as claimed in claim 1, wherein
the wind power installation has an operating controller and a safety controller, and
the safety stop is controlled by the safety controller, and
stopping aerodynamic rotor is controlled by the operating controller if there is no safety stop.

6. The method as claimed in claim 1, wherein
the triggering event is associated with one of different trigger classes,
the one of the plurality of control strategies is selected based on a trigger class with which the triggering event is associated, and
a safety stop is assigned to each of the different trigger classes.

7. The method as claimed in claim 6, wherein
the triggering event is a safety-relevant triggering event or a violation of a safety limit value, and
the different trigger classes include:
a first trigger class with corresponding triggering events that trigger a stop of the wind power installation into a coasting operation, wherein the rotor blades are moved to a stop at a blade adjustment speed which has an average value below a first limit value,
a second trigger class with corresponding triggering events that trigger a stop of the wind power installation into a coasting operation, wherein the rotor blades are moved to a stop at a blade adjustment speed which has an average value above the first limit value,
a third trigger with corresponding triggering events that trigger a stop of the wind power installation to a standstill without falling under a fourth trigger class, wherein the fourth trigger has triggering events which are stored as safety-relevant trigger events and occur when a sensor value violates a safety limit value.

8. The method as claimed in claim 1, wherein
the triggering event is one of a plurality of triggering events for triggering the safety stop,
the plurality of triggering events have corresponding priority levels so that if more than one triggering event trigger the safety stop, a corresponding control strategy assigned to a triggering event having the highest priority level is used, and
the one of the plurality of control strategies is changed when at least one triggering event with a higher priority level than the triggering event occurs or the triggering event Of ceases to exist.

9. The method as claimed in claim 1, wherein
a pitch system is present for adjusting the rotor blades,
a default trajectory is stored in the pitch system, and
the default trajectory is used to adjust the rotor blades if the pitch system loses a communication link to a safety system,
adjustment of the rotor blades for the safety stop is specified by the safety system instead of using the default trajectory.

10. The method as claimed in claim 9, wherein
the safety system for controlling the safety stop has at least one of a microcontroller certified for the safety system or a communication hardware certified for the safety system,
the safety stop is only triggered based on a signal which meets at least one predetermined safety criterion, and
the signal is performed redundantly.

11. The method as claimed in claim 1, wherein the triggering events is selected from a list comprising:
a speed exceeding a predetermined speed limit speed indicating a sensor error,
a tower vibration or a tower acceleration exceeding a predetermined tower vibration limit value or a predetermined tower acceleration limit value,
a blade angle difference between two of the rotor blades exceeding a predetermined differential angle limit value,
the blade angle of at least one rotor blade falling below a predetermined minimum blade angle,
an emergency stop switch being actuated,
a generator vibration is above a predetermined generator vibration limit value,
a network error or a network disconnection,
a detected pitch rate deviating from a pitch rate expected based on a detected rotor speed by more than a predetermined maximum deviation rate,
pitch rates based on the speed,
detected rotor blade vibration exceeding a predetermined limit value, and
a detected oblique incident flow exceeding a predetermined oblique incident flow measurement.

12. The method as claimed in claim 1, wherein
if the triggering event triggers a safety stop, the trigger event is identified and
a temporal pitch rate profile is selected based on the identified trigger event, or
a temporal generator profile is selected based on the identified trigger event, the temporal generator profile designating a temporal curve of a generator torque or of a generator power.

13. The method as claimed in claim 1, wherein
stopping the rotor by the safety stop is controlled such that one or more load limits do not exceeded 90%, the one or more load limits being selected from a list comprising:
a maximum blade load on the rotor blades,
a maximum blade vibration amplitude,
a maximum tower bend,
a maximum tower vibration amplitude,
a maximum tower acceleration, and
a maximum rotor shaft bend or axle journal bend of an axle journal carrying the rotor.

14. The method as claimed in claim 1, wherein
controlling of the safety stop by a safety system is integrated into a controller so that adjustment of the rotor blades or controlling of a generator torque or of a generator power, is performed based on at least one detected or estimated load such that at least one load complies with a predetermined load limit value at all times.

15. The method as claimed in claim 14, wherein a safety procedure for performing the safety stop is performed such that
the safety stop can be performed by the safety system even in the event that the operating controller fails,
the safety system is certified to safely control the safety stop when the operating controller fails, or
the safety system is superordinate to the operating controller such that the safety system monitors the operating controller.

16. The method as claimed in claim 1, wherein
the one of the plurality of control strategies is further selected based on at least one operating state of the wind power installation at a time of the triggering event, and
the one of the plurality of control strategies is adapted during the control of the safety stop, based on at least one continuously detected operating state.

17. A wind power installation, comprising:
an aerodynamic rotor with rotor blades with adjustable blade angle, wherein
the aerodynamic rotor is configured to operate at a variable rotor speed,
the wind power installation is formed such that
the rotor blades are configured to move toward a feathered position in order to stop the rotor,
stopping operation of the wind power installation is triggered by a trigger event, and
a safety stop is triggered based on the triggering event, one of a plurality of control strategies for performing the safety stop is selected in accordance with the triggering event.

18. The wind power installation as claimed in claim 17, wherein
the wind power installation has an installation controller,
configured to control an operation of the wind power installation including the stopping operation, and
the installation controller has an operating controller and a safety controller overlaid on the operating controller.
